(19) United States
(12) Patent Application Publication
(10) Pub. No.: US 2014/0060050 A1
(43) Pub. Date: Mar. 6, 2014

(54) ORGANIC RANKINE CYCLE FOR CONCENTRATED SOLAR POWER SYSTEM

(71) Applicants: Bhaskara Kosamana, Bangalore (IN); Joydeep Chowdhury, Kolkata (IN); Arunachalam Chettiyar, Bangalore (IN); Saravanaram T., Bangalore (IN); Rakesh Govindasamy, Bangalore (IN)

(72) Inventors: Bhaskara Kosamana, Bangalore (IN); Joydeep Chowdhury, Kolkata (IN); Arunachalam Chettiyar, Bangalore (IN); Saravanaram T., Bangalore (IN); Rakesh Govindasamy, Bangalore (IN)

(73) Assignee: NUOVO PIGNONE S.p.A., Florence (IT)

(21) Appl. No.: 14/008,848

(22) PCT Filed: Mar. 30, 2012
(86) PCT No.: PCT/EP12/55761

§ 371 Date: Nov. 19, 2013

(30) Foreign Application Priority Data
Apr. 1, 2011 (IN) 940/DEL/2011

(51) Int. Cl. F03G 6/06; F03G 6/00

(52) U.S. Cl. CPC F03G 6/067; F03G 6/005
USPC 60/651; 60/641.8; 60/641.15

(57) ABSTRACT

Systems and methods for transforming solar energy into mechanical and/or electrical energy by using an ORC fluid in an ORC cycle configuration. The ORC cycle configuration includes a heat source that vaporizes the ORC fluid and an expander that expands the vaporized ORC fluid to produce the energy.

### CROSS-REFERENCE TO RELATED APPLICATIONS

This is a national stage application under 35 USC §371 (c) of prior filed, co-pending PCT Patent Application Serial Number PCT/EP2012/055761, filed on Mar. 30, 2012 which claims priority to IN Application Serial No 940/DEL/2011, filed Apr. 1, 2011, the disclosures of which are hereby incorporated in their entirety by reference herein.

### BACKGROUND OF THE INVENTION

Embodiments of the present invention generally relate to power generation systems and, more particularly, to Organic Rankine Cycle (ORC) systems having a solar power source.

Rankine cycles use a working organic fluid in a closed cycle to gather heat from a heating source or a hot reservoir and to generate power by expanding a hot gaseous stream through a turbine or an expander. The expanded stream is condensed in a condenser by transferring heat to a cold reservoir and pumped up to a heating pressure again to complete the cycle. Solar power sources are known to be used as the heating source or the hot reservoir. For example, Concentrating Solar Power (CSP) systems use lenses or mirrors and tracking systems to focus a large area of sunlight into a small beam. The concentrated heat is then used as the heat source for a conventional power plant. A wide range of concentrating technologies exists. The most developed are the parabolic trough, the concentrating linear fresnel reflector, the Stirling dish and the solar power tower. Various techniques are used to track the Sun and focus light. In all of these systems a working fluid is heated by the concentrated sunlight, and is then used for power generation or energy storage.

A known ORC system is discussed with regard to FIG. 1. FIG. 1 shows a power generation system 10 that includes a heat exchanger 2, also known as a boiler, a turbine 4, a condenser 6 and a pump 8. Walking through this closed loop system, beginning with the heat exchanger 2, an external heat source 3, e.g., hot flue gases, heats the heat exchanger 2. This causes the received pressurized liquid medium 12 to turn into a pressurized vapor 14, which flows to the turbine 4. The turbine 4 receives the pressurized vapor stream 14 and can generate power 16 as the pressurized vapor expands. The expanded lower pressure vapor stream 18 released by the turbine 4 enters the condenser 6, which condenses the expanded lower pressure vapor stream 18 into a lower pressure liquid stream 20. The lower pressure liquid stream 20 then enters the pump 8, which both generates the higher pressure liquid stream 12 and keeps the closed loop system flowing. The higher pressure liquid stream 12 then is pumped to the heat exchanger 2 to continue this process.

A known working fluid that can be used in a Rankine cycle is an organic working fluid. Such an organic working fluid is referred to as an ORC fluid. ORC systems have been deployed as retrofits for engines as well as for small-scale and medium-scale gas turbines, to capture waste heat from the hot flue gas stream. This waste heat may be used in a secondary power generation system to generate up to an additional 20% power on top of the power delivered by the engine producing the hot flue gases alone.

FIG. 2 illustrates a known ORC system that utilizes solar power sources. System 30 includes a solar collector 32, a steam-engine with heat exchanging condenser 34, a storage tank 36 for a working fluid, and a pump 38 for delivering the working fluid to the solar collector 32. The solar collector 32 is equipped with a leveling valve 40 on its inlet for an ORC working fluid pumped by pump 38 from the storage tank 36 to an upper tank 42. The vaporized ORC working fluid is provided from the solar collector 32 to a steam turbine 44 which may be connected to a power generator 46.

However, the existing solar power systems are not efficient. Accordingly, systems and methods for improving the efficiency of ORC systems in power generation systems are desirable.

### BRIEF SUMMARY OF THE INVENTION

According to an exemplary embodiment of the invention, there is a system for generating energy using an Organic Rankine Cycle (ORC). The system comprises a single closed loop configured to use an ORC fluid for the ORC, and a solar power source configured to use solar energy to transform an ORC liquid to a vaporized ORC.

According to another exemplary embodiment of the invention, there is a method for power generation using an Organic Rankine Cycle (ORC), the method comprising transforming ORC liquid through heating with a solar power source into a vaporized ORC in a closed system, expanding the vaporized ORC in an expander to produce energy, and cooling the vaporized ORC to change back to the ORC liquid and returning the ORC liquid to the solar power source.

According to another exemplary embodiment of the invention, there is a system for generating energy using an Organic Rankine Cycle (ORC). The system comprising a first closed system configured to use as medium an oil based fluid, and a second closed system configured to use as medium an ORC fluid, wherein the first closed system is configured to exchange heat with the second closed system, wherein the first closed system includes a solar power source configured to use solar energy to transform an ORC liquid to a vaporized ORC in the second closed system.

According to another exemplary embodiment of the invention, there is a method for power generation using an Organic Rankine Cycle (ORC). The method comprising heating with a solar power source an oil based fluid in a first closed system, and expanding a vaporized ORC fluid in a second closed system for producing energy, wherein the oil based fluid of the first closed system is configured to exchange heat with an ORC liquid of the second closed system.

### BRIEF DESCRIPTION OF THE DRAWINGS

The accompanying drawings illustrate exemplary embodiments of the present invention in which:

FIG. 1 is a schematic diagram of an ORC cycle;

FIG. 2 is a schematic diagram of an ORC cycle configuration used with a solar power source;

FIG. 3 is a schematic diagram of an ORC cycle configuration used with a solar power source according to an exemplary embodiment of the present invention;

FIG. 4 is a schematic diagram of an ORC cycle configuration used with a solar power source and a secondary heat source according to an exemplary embodiment of the present invention;

FIG. 5 is a schematic diagram of an ORC cycle configuration used with a solar power source in a two closed loops system according to an exemplary embodiment of the present invention;

FIG. 6 is a schematic diagram of an ORC cycle configuration used with a solar power source and a secondary heat source in a two closed loops system according to an exemplary embodiment of the present invention;

FIG. 7 is a flowchart of a method for using an ORC cycle configuration with a solar power source according to an exemplary embodiment of the present invention;

FIG. 8 is a flow chart of an ORC cycle configuration used with a solar power source in a two closed loops system according to an exemplary embodiment of the present invention;

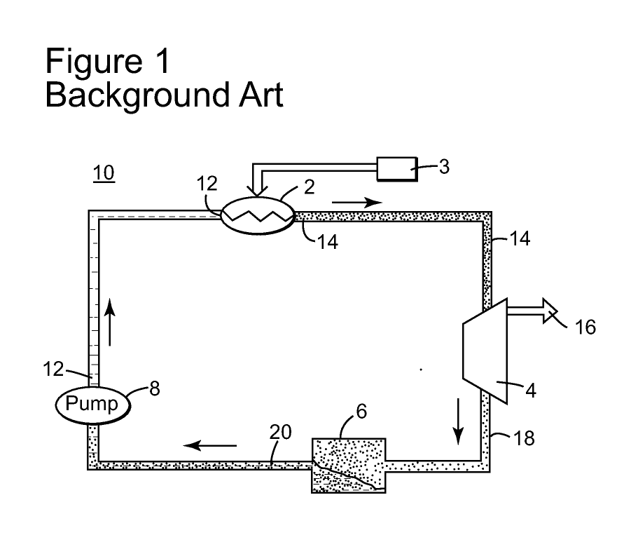

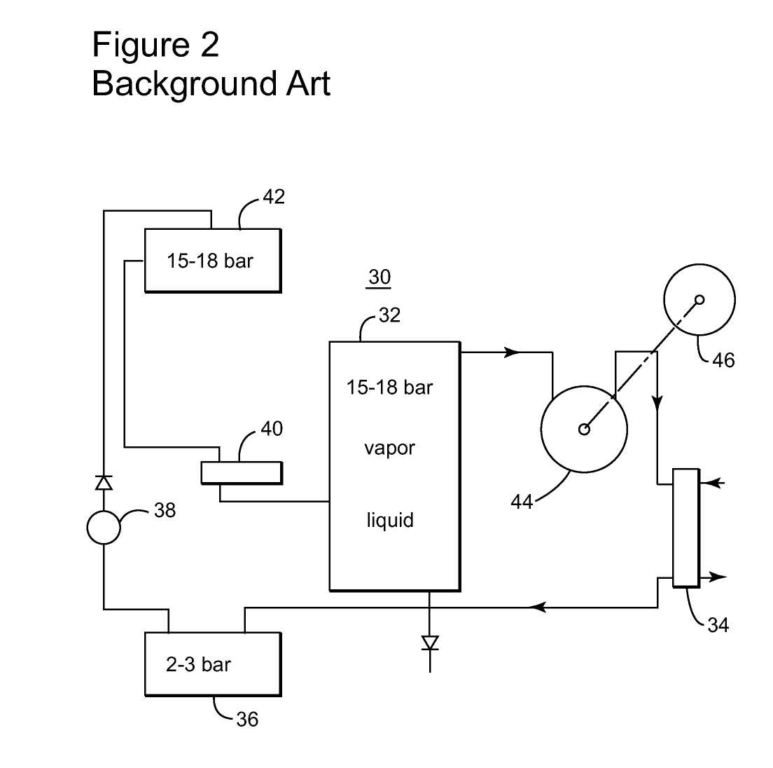

### DETAILED DESCRIPTION OF THE INVENTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims. For simplicity, the following description refers to an Organic Rankine Cycle (ORC) used with a solar power source for producing energy with an expander. However, the solar power source may be different, or the expander may be replaced with another turbo-machine for producing energy. Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

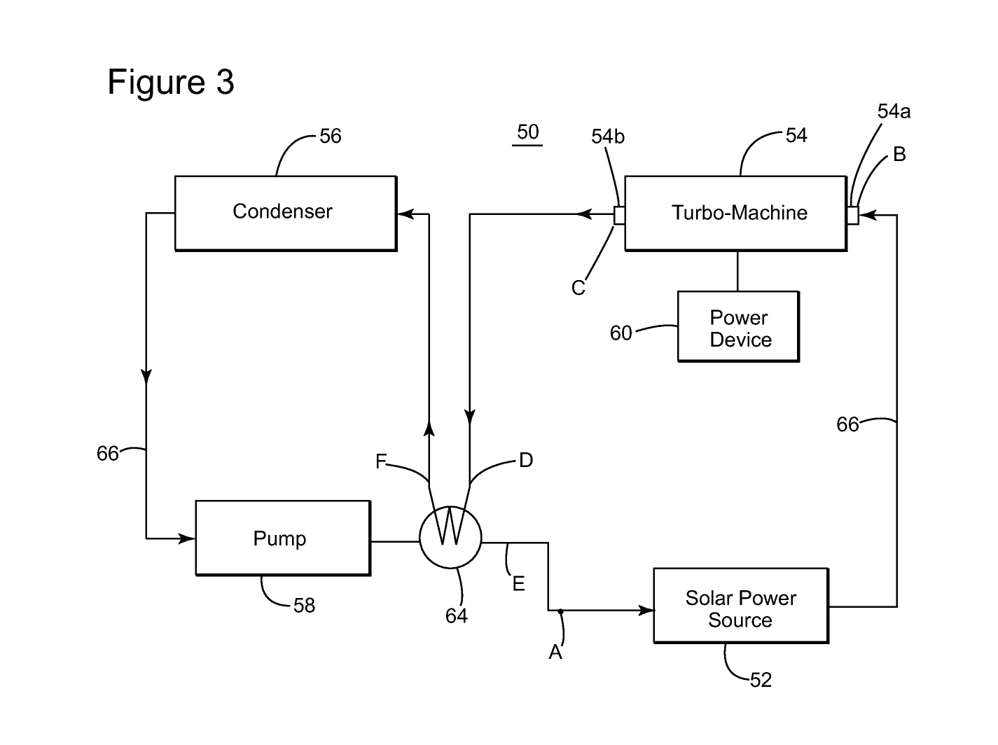

According to an exemplary embodiment of the invention, illustrated in FIG. 3, a system 50 for power generation using an ORC includes a solar power source 52 that is configured to vaporize an ORC fluid flowing through the system and a turbo-machine 54 configured to generate energy/power by expanding the vaporized medium. The ORC fluid may be any organic fluid suitable for ORC. A condenser 56 ensures that the vaporized medium is returned to its liquid phase and a pump 58 increases the pressure of the liquid medium and maintains the medium flowing through the system.

The medium may be an organic fluid traditionally used in ORC systems. However, for an improved efficiency, a cyclopentane based fluid is used as the medium according to an application. Cyclopentane is a highly flammable alicyclic hydrocarbon with chemical formula C₅H₁₀. It consists of a ring of five carbon atoms each bonded with two hydrogen atoms above and below the plane. It occurs as a colorless liquid with a petrol-like odor. Its melting point is −94° C. and its boiling point is 49° C. Other mediums may also be used. According to an exemplary embodiment of the invention, the ORC medium includes cyclopentane mixed with one or more of 2-Methyl Pentane, npentane and isopentane. For example, one possible combination is cyclopentane around 95%, 2-Methyl Pentane around 3.5%, npentane 0.75% and isopentane around 0.75%.

The solar power source 52 may be any of the known solar sources. However, the embodiments of the invention discussed next are optimized for concentrated solar power (CSP) systems. A CSP system is different from a photovoltaic system. Photovoltaic systems directly transform solar energy into electricity. A CSP system needs a medium to be vaporized based on the solar energy and then that energy is extracted with an appropriate turbo-machine, e.g., an expander or a turbine. Thus, the medium used in the embodiment shown in FIG. 3 experiences various thermodynamic processes as it passes the various elements of the system.

The turbo-machine 54 may be any machine that is configured to extract energy from the vaporized medium and transform this energy into, e.g., mechanical energy to drive a turbo-machine, e.g., a pump, a compressor, etc. The turbo-machine may also be used to produce electrical power or for other purposes known in the art. In this regard, an expander is configured to receive a vaporized medium which determines airfoils or an impeller of the expander to rotate around a transversal axis. Thermodynamic energy of the gas (vaporized medium) is extracted during the expansion process which makes a shaft (that holds the airfoils or impeller) of the expander to rotate, thus generating the mechanical energy. This mechanical energy may be used to activate a power device 60, for example, a compressor or an electrical power generator for producing electricity.

The expander may be a single stage or plural stages expander. A single stage expander has only one impeller and the vaporized gas is provided to the exhaust of the expander after passing the single impeller. A multi-stage impeller has plural impellers and the expanded medium from one impeller is provided to a next impeller for further extracting energy from the medium. The expander may be a centrifugal or an axial machine. A centrifugal expander receives the vaporized medium along a first direction (e.g., Y axis) and discharges the expanded medium at a second direction (e.g., X direction) substantially perpendicular to the first direction. In other words, a centrifugal force is used to rotate the shaft of the expander. In an axial expander the medium enters and exits the expander along the same direction, similar to the jet engine of an airplane.

The condenser 56 may be air cooled or water cooled and its purpose is to further cool the expanded medium from the turbo-machine 54 so that the medium becomes liquid. The pump 58 may be any pump known in the art and suitable for increasing the pressure of the medium to a desired value. Heat from the medium exhausted from the expander 54 may be removed in a recuperator 64 and provided to the liquid medium being provided to the solar power source 52. The recuperator 64 may be as simple as a container having two pipes that share a same ambient. For example, the liquid medium (from the pump) flows through a first pipe while the vaporized medium (from the expander) flows through a second pipe. Because the same ambient is present around the first and second pipes, heat from the second pipe migrates to the first pipe, thus heating the liquid medium. Other more sophisticated recuperators may be used.

The flow of the medium through the system 50 is now discussed in more details. Assume that the medium flow is followed from point A. At this point the liquid medium is at a high pressure (e.g., 40 bar) due to the pump 58 and at a low temperature (e.g., 55° C.). After the liquid medium passes through the solar power source 52, its temperature is increased (e.g., at 250° C.). The numbers used in this and other exemplary embodiments of the invention are for illustration purposes and not intended to limit the embodiments. Those skilled in the art would recognize that these numbers change from system to system as the characteristics of the system changes.

While passing the solar power source 52, the medium may undergo a phase transformation, i.e., from liquid medium to vaporized medium. During the passing through the solar power source 52, the solar energy is transferred from the sun light to the medium. The vaporized medium arrives at point B and enters an inlet 54a of the expander 54 and makes the shaft of the expander to rotate, transforming the solar energy into mechanical energy. The expanded medium, which may be still a gas and not a liquid (e.g., temperature at point C is about 140° C. and pressure is about 1.3 bar) is then released from the expander at outlet 54b.

As there is still energy (heat) left in the vaporized medium at point C, this medium is directed to the recuperator 64 to further remove heat from it. The heat removed in the recuperator 64 from the vaporized medium at point D is provided to the liquid medium at point E (inside the recuperator) prior to providing the liquid medium to the solar power source. The cooled vaporized medium at point F, is now cooled down in the condenser 56 to bring it back to a liquid phase. Then, the liquid medium is provided to the pump 58 and the cycle repeats. It is noted that the piping 66 that takes the medium from a component to the other is sealed so that the medium does not escape outside the system 50. In other words, the system shown in FIG. 3 is a closed loop system.

The above discussed system increases the conversion efficiency of the solar energy to electrical energy when an electric power generator 60 is used. Also, the present system does not need water for its medium and the medium may be directly vaporized by the solar power source. If using the cyclopentane based fluid, it is noted that this medium is directly vaporized in the solar power source as the boiling temperature of cyclopentane is around 49° C.

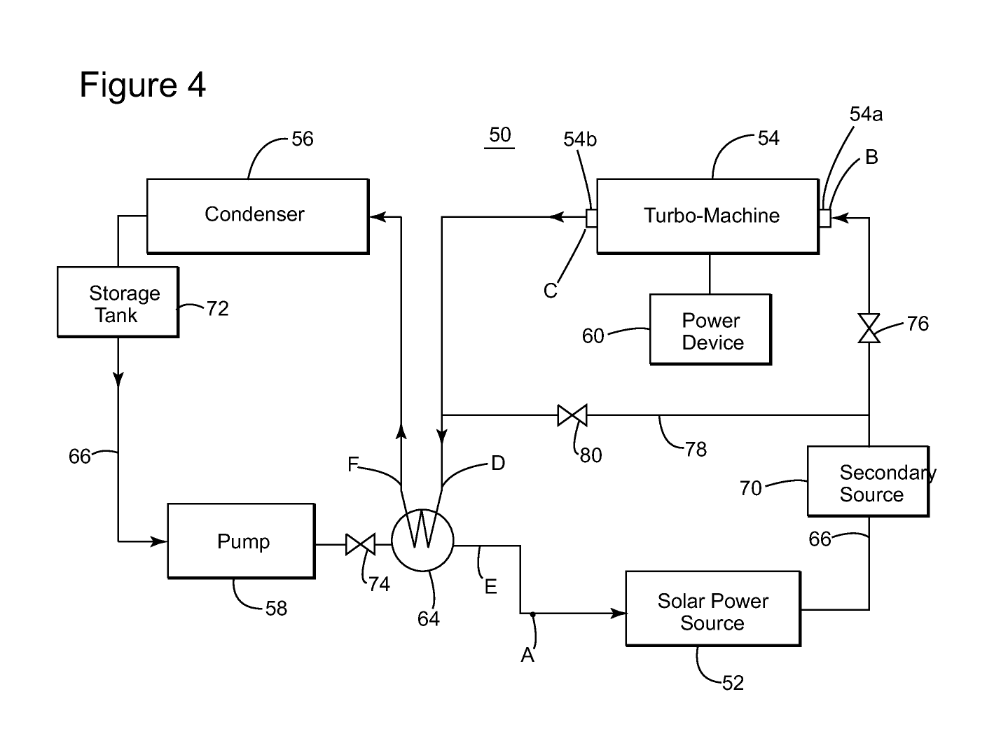

According to another embodiment of the present invention, illustrated in FIG. 4, a secondary heat source 70 may be added, for example, downstream of the solar power source 52 and upstream the expander 54. In another application, the secondary power source 70 may be provided at location A. The secondary power source may be solar, geothermal, fossil, nuclear or other known power sources. For example, the exhaust of a turbo-machine or a power plant may be the secondary power source.

In another application, a storage tank 72 may be provided for storing of the cyclopentane based medium. In an embodiment of the present invention, the storage tank 72 is provided downstream the condenser 56. Various valves 74 and 76 may be provided along the piping system for controlling the amount of the medium flowing in the system. In still another embodiment, a balancing line 78 and a valve 80 may be provided for controlling the flow of the medium through the system.

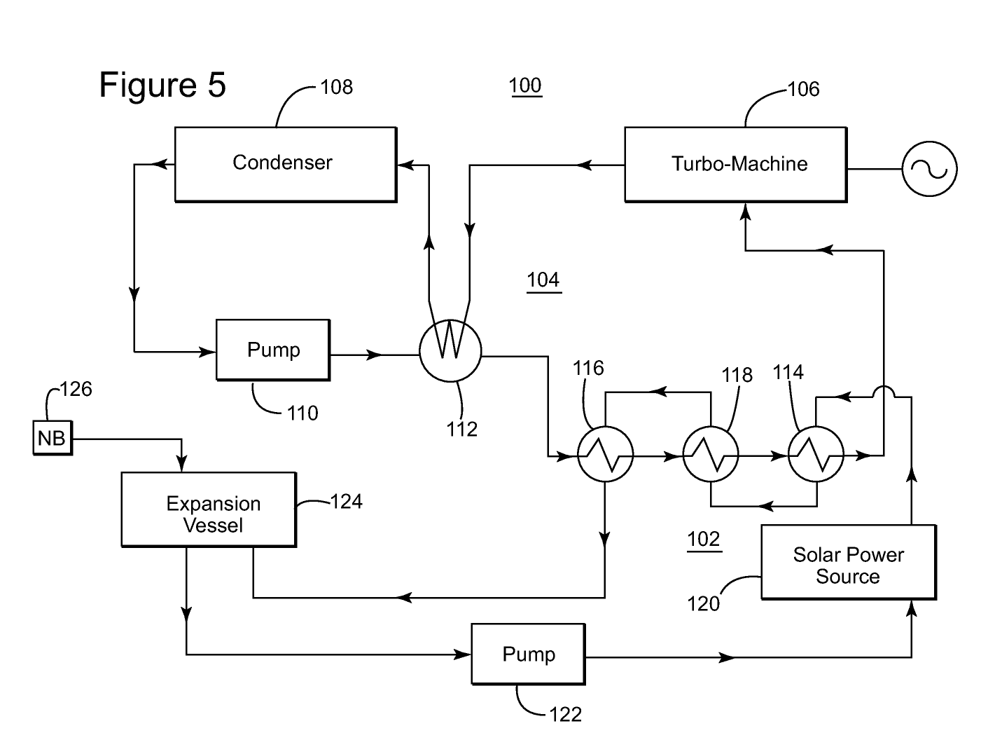

FIG. 5 illustrates another embodiment of the present invention, wherein, the system 100 may include a first closed loop system 102 and a second closed loop system 104. The second closed loop system 104 may include a turbo-machine 106, a condenser 108, a pump 110 and a recuperator 112 similar to those shown in FIGS. 3 and 4 and also similarly connected to the system of the embodiments shown in FIGS. 3 and 4. However, instead of the solar power source shown in FIG. 3, the second closed loop system may include one or more vaporizers 114 and one or more heat exchanging devices 116. FIG. 5 shows two heat exchanging devices 116 and 118 but one device is enough for the system to function. In one application, no heat exchanging device is necessary.

The first closed loop system 102 may include a solar power source 120, similar to the solar power source 52 of FIG. 3 and a pump 122 similar to the pump 58 of FIG. 3. The first closed loop system 102 may use an oil based substance as the flowing medium while the second closed loop system 104 may be an ORC system that uses a cyclopentane based fluid as the flowing medium. The organic medium of the second closed loop system 104 is not circulating through the solar power source 120 in this embodiment of the invention but rather is placed in thermal contact with the oil based substance of the first closed loop system 102 for transferring heat from the solar power source.

In this regard, the oil based substance from the solar power source 120 vaporizes in the vaporizer 114 the medium of the second closed loop system and provides the vaporized medium to the turbo-machine 106. In addition, it is possible to further use the oil based substance to pre-heat the medium of the second closed loop cycle in one or more heat exchanging devices 116 and 118. However, according to an exemplary embodiment of the present invention, the heat exchanging devices 116 and 118 may be omitted. The cooled oil based substance arrives then at an expansion vessel 124 from which it flows to the pump 122 for being again provided to the solar power source 120. The oil based substance does not mix with the medium of the second closed loop system or with the ambient. The expansion vessel 124 may be in fluid communication with a nitrogen source 126 that is configured to nitrogen blanket a top portion (inside) of the expansion vessel 124. Although the nitrogen enters inside the expansion vessel, the nitrogen does not flow through the first closed loop system 102 as it flows above the oil based substance.

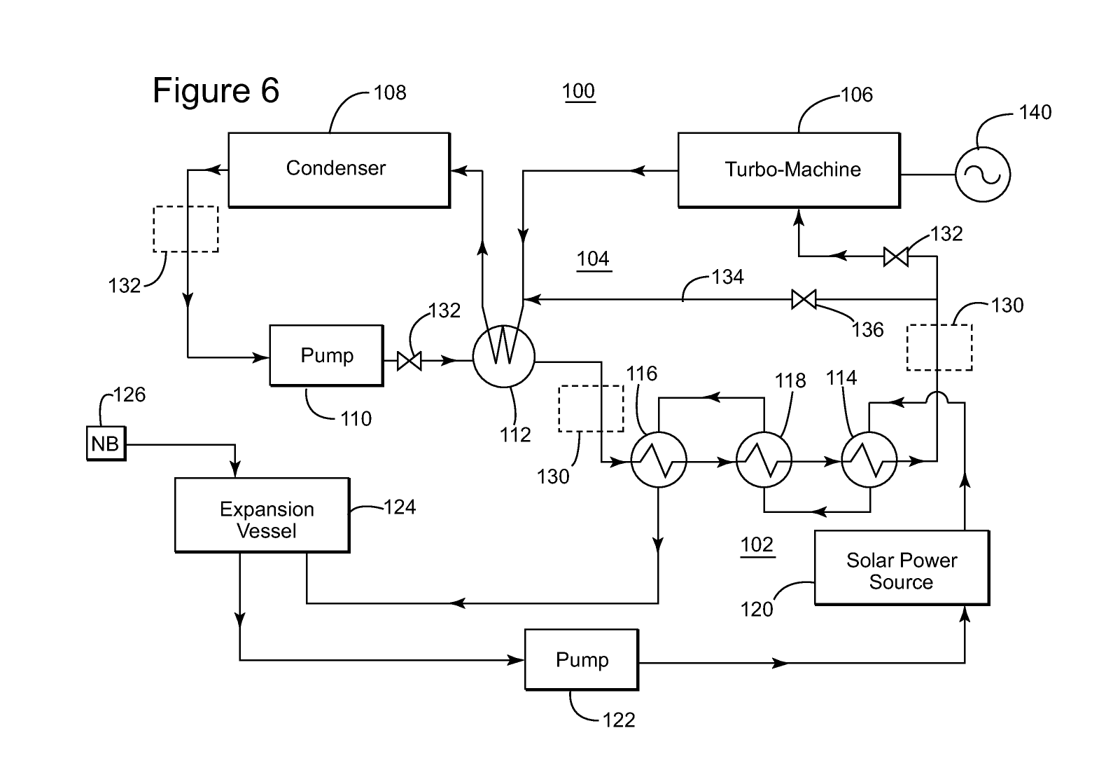

According to an embodiment of the present invention, illustrated in FIG. 6, various elements, as shown in FIG. 4, may be added to the system 100. For example, secondary heat sources 130 may be added in the second closed loop system, upstream or downstream from the vaporizer 114 for further heating the medium of the second closed loop system. Valves 132 may be added to control the flow of the medium and a balancing line 134 with corresponding valve 136 may be provided in the second closed loop system. A generator 140 or other turbo-machine may be connected to the expander 106 in the second closed loop system 104.

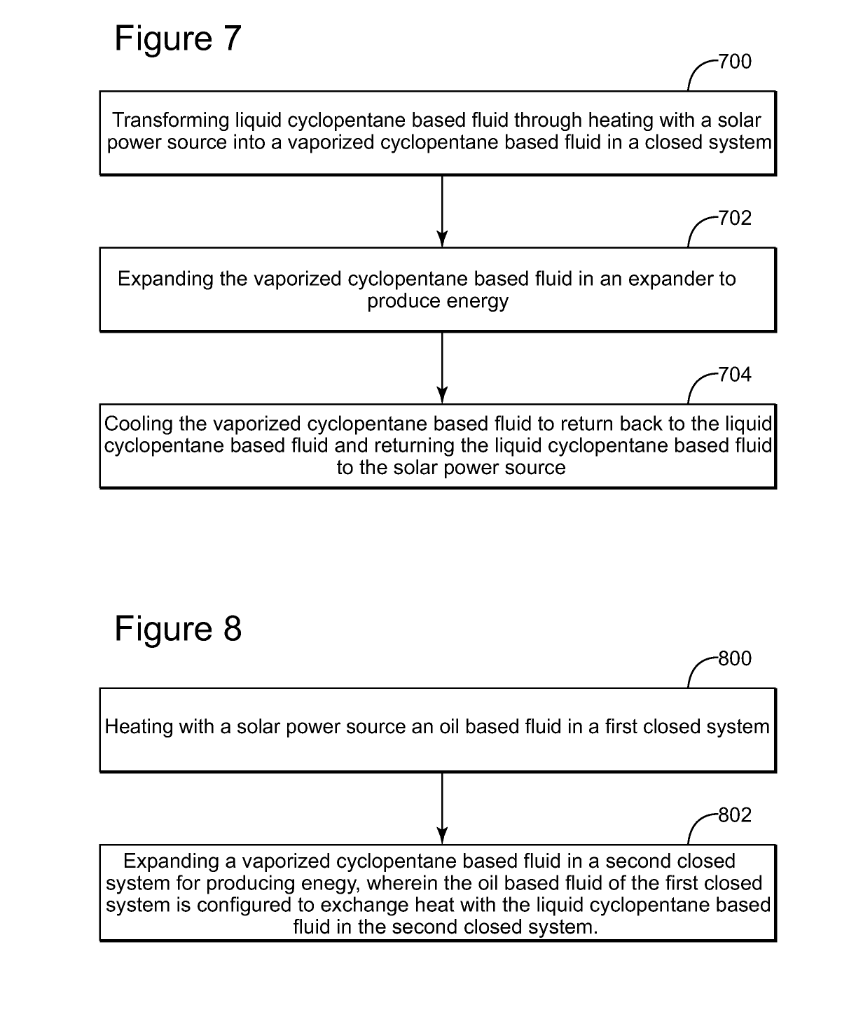

Methods for operating such systems are now discussed. According to an embodiment of the present invention, illustrated in FIG. 7, there is a method for generating energy using an ORC. The method includes a step 700 of transforming liquid cyclopentane based fluid through heating with a solar power source into a vaporized cyclopentane based fluid in a closed system; a step 702 of expanding the vaporized cyclopentane based fluid in an expander to produce energy; and a step 704 of cooling the vaporized cyclopentane based fluid to return back to the liquid cyclopentane based fluid and returning the liquid cyclopentane based fluid to the solar power source.

According to another embodiment of the present invention, illustrated in FIG. 8, there is a method for generating energy using an ORC. The method includes a step 800 of heating with a solar power source an oil based fluid in a first closed system; and a step 802 of expanding a vaporized cyclopentane based fluid in a second closed system for producing energy, wherein the oil based fluid of the first closed system is configured to exchange heat with the liquid cyclopentane based fluid in the second closed system.

The disclosed exemplary embodiments provide a system and a method for transforming solar energy into mechanical energy or electrical energy. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present embodiments are described in particular combinations, each feature or element can be used alone without the other features and elements of the embodiments or in various combinations with or without other features and elements disclosed herein.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A system (50) for generating energy using an Organic Rankine Cycle (ORC), the system comprising:
a single closed loop configured to use an ORC fluid for the ORC; and
a solar power source (52) configured to use solar energy to transform an ORC liquid to a vaporized ORC.

2. The system of claim 1, wherein the single closed loop comprises:
an expander fluidly connected to the solar power source and configured to receive the vaporized ORC and expand it so that a rotoric part of the expander rotates;
a recuperator fluidly connected to an output of the expander and configured to remove heat from the vaporized ORC;
a cooling device fluidly connected to the recuperator and configured to transform the vaporized ORC back to the ORC liquid; and
a pump fluidly connected between the cooling device and the recuperator and configured to pump the ORC liquid to the recuperator,
wherein the pumped ORC liquid from the pump receives heat in the recuperator from the vaporized ORC coming from the expander.

3. The system of claim 2, further comprising:
a power generator coupled to the expander and configured to produce electric energy when the rotoric part of the expander is rotated by an expansion of the vaporized ORC.

4. The system of claim 2, further comprising:
a compressor or another turbo-machine connected to the expander and configured to be driven by the expander.

5. The system of claim 2, further comprising:
a storage tank fluidly provided between the cooling device and the pump.

6. The system of claim 2, wherein the expander has only one stage and the expander is an axial expander.

7. The system of claim 2, further comprising:
piping fluidly connecting elements of the system; and
a balancing by pass line fluidly connecting an incoming pipe to the expander with an outgoing pipe of the expander.

8. The system of claim 1, wherein the solar power source is configured to concentrate solar power.

9. The system of claim 8, further comprising:
an additional power source connected upstream or downstream to the solar power source to further heat the ORC fluid.

10. A method for power generation using an Organic Rankine Cycle (ORC), the method comprising:
transforming ORC liquid through heating with a solar power source (52) into a vaporized ORC in a closed system;
expanding the vaporized ORC in an expander (54) to produce energy; and
cooling the vaporized ORC to change back to the ORC liquid and returning the ORC liquid to the solar power source.

11. A system (100) for generating energy using an Organic Rankine Cycle (ORC), the system comprising:
a first closed system (102) configured to use as medium an oil based fluid; and
a second closed system (104) configured to use as medium an ORC fluid, wherein the first closed system is configured to exchange heat with the second closed system,
wherein the first closed system includes a solar power source (120) configured to use solar energy to transform an ORC liquid to a vaporized ORC in the second closed system.

12. The system of claim 11, wherein the second closed system comprises:
an expander fluidly configured to receive the vaporized ORC and expand it so that a rotoric part of the expander rotates;
a recuperator fluidly connected to an output of the expander and configured to remove heat from the vaporized ORC;
a cooling device fluidly connected to the recuperator and configured to transform the vaporized ORC back to the ORC liquid;
a pump fluidly connected between the cooling device and the recuperator and configured to pump the ORC liquid to the recuperator; and
one or more heat exchanging devices configured to add heat to the ORC liquid to transform it into a vaporized ORC,
wherein the pumped ORC liquid from the pump receives heat in the recuperator from the vaporized ORC coming from the expander, and
the one or more heat exchanging devices are fluidly connected between the recuperator and the expander.

13. The system of claim 12, wherein the one or more heat exchanging devices are configured to remove heat from the oil based fluid of the first closed system.

14. The system of claim 13, wherein the one or more heat exchanging devices comprises:
a vaporizer fluidly connected to the expander and configured to vaporize the ORC liquid in the second closed system; and
at least one preheater fluidly connected between the recuperator and the vaporizer and configured to heat the ORC liquid by removing heat from the oil based fluid of the first closed system.

15. The system of claim 12, wherein the first closed system comprises:
a storage vessel fluidly connected to the one or more heat exchanging devices; and
a pump fluidly connected to the solar power source and configured to pump the oil based fluid through the first closed system.

16. The system of claim 12, further comprising:
a power generator coupled to the expander and configured to produce electric energy when the rotoric part of the expander is rotated by an expansion of the vaporized ORC.

17. The system of claim 12, further comprising:
a compressor or another turbo-machine connected to the expander and configured to use the rotation energy produced by the expander.

18. The system of claim 11, further comprising:
an additional power source connected in the second closed system to further heat the ORC fluid.

19. A method for power generation using an Organic Rankine Cycle (ORC), the method comprising:
heating with a solar power source (120) an oil based fluid in a first closed system (102); and
expanding a vaporized ORC fluid in a second closed system (104) for producing energy, wherein the oil based fluid of the first closed system is configured to exchange heat with an ORC liquid of the second closed system.

20. The method of claim 19, further comprising:
vaporizing the ORC liquid with at least one heat exchanging device connected between the first and second closed systems.
